(19) United States
(12) Patent Application Publication
(10) Pub. No.: US 2026/0245785 A1
(43) Pub. Date: Aug. 20, 2026

(54) COMPOSITE MAGNETIC MEMBER, ELECTRIC POWER GENERATING ELEMENT, ELECTRICITY GENERATING SYSTEM, AND ENCODER

(71) Applicant: Panasonic Intellectual Property Management Co., Ltd., Osaka (JP)

(72) Inventors: SHINICHI TSUTSUMI, Kyoto (JP); SHUGO FUKUDA, Hyogo (JP); KAZUYA KATAYAMA, Osaka (JP); YU NISHITANI, Hyogo (JP)

(21) Appl. No.: 19/489,607

(22) PCT Filed: May 14, 2024
(86) PCT No.: PCT/JP2024/017757

§ 371 Date: Dec. 3, 2025

(30) Foreign Application Priority Data
Jun. 8, 2023 (JP) 2023-095041

(51) Int. Cl. H01F 27/28; H01F 27/24; H01F 27/32

(52) U.S. Cl. CPC H01F 27/2823; H01F 27/24; H01F 27/32

(57) ABSTRACT

Variations in the amount of power generated by a power generating element are reduced. A composite magnetic member is a magnetic member that generates a large Barkhausen effect by a change in an external magnetic field, and includes: a wire-shaped magnetic member that extends in a first direction; two flux concentrating members that are separated from each other and are arranged side by side along the first direction, the two flux concentrating members (150) being provided with an opening into which a part of the magnetic member is inserted; and resin member that fixes the magnetic member and the two flux concentrating members. Resin member includes first covering portion that covers the outer peripheral surface of the magnetic member between the at least two flux concentrating members. A space for disposing the coil is provided between the two flux concentrating members.

### TECHNICAL FIELD

The present disclosure relates to a composite magnetic member, a power generation element, a power generation system, and an encoder.

### BACKGROUND ART

Conventionally, as an encoder for detecting rotation or the like of a motor, there is known an encoder in which a power generation element using a large Barkhausen effect is used in order to detect rotation without using a battery (for example, Patent Document 1). Such a power generation element has, for example, a configuration in which a coil is wound around a magnetic member that produces a large Barkhausen effect. In the magnetic member that generates the large Barkhausen effect, the magnetic flux density rapidly changes due to a change in the external magnetic field, and thus electric power is generated in the coil wound around the magnetic member due to the rapid change in the magnetic flux density.

In addition, in such a power generation element, power generation performance can be enhanced by providing the flux concentrating member at the end portion of the magnetic member. For example, Patent Literature 2 discloses a power generating element in which a magnetic member is inserted into an insertion portion of a flux concentrating member, and the magnetic member and the flux concentrating member are in contact with each other at the insertion portion.

### CITATION LIST

### Patent Literature

Patent Literature 1: Japanese Patent No. 6647478
Patent Literature 2: Japanese Patent No. 7109713

### SUMMARY OF THE INVENTION

In the power generation element using the magnetic member that generates the large Barkhausen effect as described above, it is required that variation in power generation amount is small. For example, when the power generation element is used for an encoder, the accuracy of detecting the rotation of the motor or the like decreases in a case where the variation in the power generation amount is large.

The present disclosure has been made to solve such a problem, and an object of the present disclosure is to provide a composite magnetic member capable of reducing variation in power generation amount of a power generation element, a power generation element using the same, a power generation system, and an encoder.

In order to achieve the above object, a composite magnetic member according to an aspect of the present disclosure is a magnetic member that generates a large Barkhausen effect by a change in an external magnetic field, the composite magnetic member including: a magnetic member extending in a first direction, the magnetic member having a wire shape; two flux concentrating members disposed side by side along the first direction while being separated from each other, the two flux concentrating members being provided with an opening into which a part of the magnetic member is inserted; and a resin member that fixes the magnetic member and the two flux concentrating members, wherein the resin member includes a first covering portion that covers an outer peripheral surface of the magnetic member at least between the two flux concentrating members, and a space for disposing a coil is provided between the two flux concentrating members.

A power generation element according to another aspect of the present disclosure includes the composite magnetic member and a coil wound around the magnetic member via the first covering portion.

A power generation system according to another aspect of the present disclosure includes: the power generation element; and a magnetic field application unit that applies a magnetic field to the power generation element and repeatedly reverses a direction of the magnetic field applied to the power generation element, wherein the power generation element generates power by reversal of the direction of the magnetic field by the magnetic field application unit.

An encoder according to another aspect of the present disclosure includes the power generation system, wherein the power generation element outputs power generated by reversal of the direction of the magnetic field by the magnetic field application unit.

According to the present disclosure, it is possible to reduce variations in the power generation amount in the power generation element.

### BRIEF DESCRIPTION OF THE DRAWINGS

FIG. 1 is a cross-sectional view illustrating a schematic configuration of an encoder according to an embodiment.

FIG. 2 is a top view of a magnet in the encoder according to the embodiment.

FIG. 3 is a cross-sectional view illustrating a schematic configuration of the power generating element according to the embodiment.

FIG. 4 is a plan view illustrating a schematic configuration of the power generating element according to the embodiment.

FIG. 5 is a flowchart illustrating an example of a method for manufacturing the power generating element according to the embodiment.

FIG. 6 is a plan view for illustrating a state in which the magnetic member and the flux concentrating member according to the embodiment are fixed in the mold.

FIG. 7 is a diagram for explaining a positional relationship between a magnetic member and a flux concentrating member in a power generating element used for measuring a generated voltage.

FIG. 8 is a schematic diagram illustrating a circuit used for measuring the power generation amount of the power generation element.

FIG. 9 is a diagram illustrating a power generation result of the power generation element.

FIG. 10 is a cross-sectional view illustrating a schematic configuration of a power generation element according to Modification Example 1 of the embodiment.

FIG. 11 is a plan view illustrating a schematic configuration of a power generation element according to Modification Example 1 of the embodiment.

FIG. 12 is a cross-sectional view illustrating a schematic configuration of a power generating element according to Modification Example 2 of the embodiment.

FIG. 13 is a cross-sectional view illustrating a schematic configuration of another power generation element according to Modification Example 2 of the embodiment.

### DESCRIPTION OF EMBODIMENT

Hereinafter, embodiments of the present disclosure will be described with reference to the drawings. It is to be noted that each of the embodiments described below shows a specific example of the present disclosure. Therefore, the numerical values, shapes, materials, structural elements, the arrangement and connection of the structural elements, and the like shown in the following embodiments are mere examples, and are not intended to limit the present disclosure. Therefore, among the structural elements in the following embodiments, structural elements not recited in any one of the independent claims of the present disclosure are described as arbitrary structural elements.

Note that the drawings are schematic diagrams and are not necessarily precise illustrations. Accordingly, the drawings are not necessarily drawn to scale. In the drawings, the same reference numerals are given to substantially the same components as those in other drawings, and redundant description will be omitted or simplified.

In addition, in the present specification, terms indicating a relationship between elements, such as equal and parallel, terms indicating a shape of an element, such as a rectangle, and numerical ranges are not expressions representing only strict meanings, but are expressions meaning that a substantially equivalent range, for example, a difference of about several % is also included.

### Embodiment

Hereinafter, a composite magnetic member according to an embodiment, a power generation element including the composite magnetic member, a power generation system including the power generation element, and an encoder including the power generation system will be described.

### Configuration

First, configurations of a composite magnetic member, a power generation element, a power generation system, and an encoder according to the present embodiment will be described.

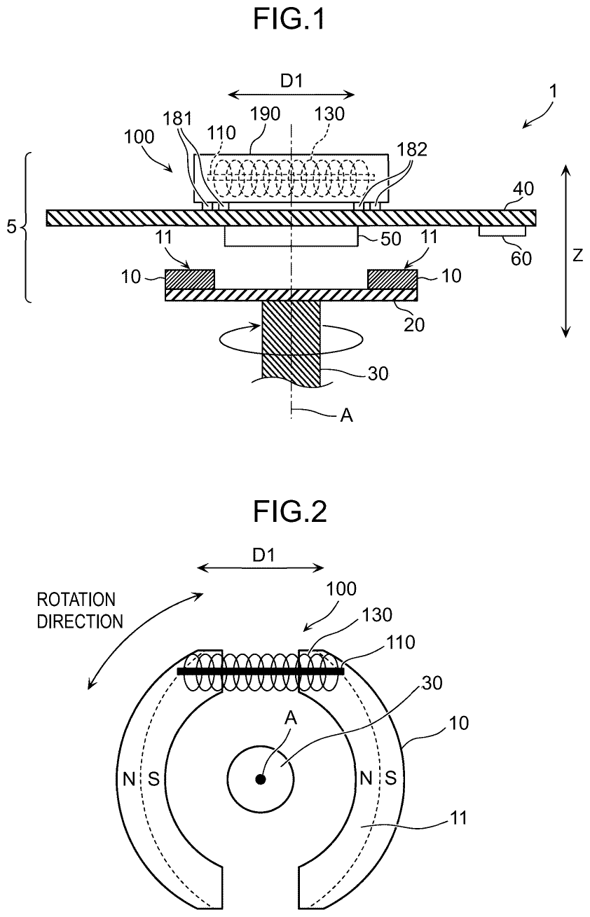

FIG. 1 is a cross-sectional view illustrating a schematic configuration of encoder 1 according to the present embodiment. FIG. 2 is a top view of magnet 10 in encoder 1 according to the present embodiment. In FIG. 1, magnetic member 110 and coil 130 accommodated in housing 190 of electric power generating element 100 are schematically shown by broken lines. In addition, for ease of viewing, in FIG. 2, all illustrations are omitted except for magnet 10, rotating shaft 30, and magnetic member 110 and coil 130 of electric power generating element 100.

Encoder 1 illustrated in FIG. 1 is, for example, a rotary encoder used in combination with a motor such as a servomotor. Encoder 1 is, for example, an absolute encoder of a power generation type. Encoder 1 detects, for example, a rotation angle, a rotation amount, the number of rotations, and the like of rotating shaft 30 such as a motor based on the electric signal generated by electric power generating element 100. Encoder 1 includes power generation system 5 including magnet 10, rotating plate 20, substrate 40, and electric power generating element 100, control circuit 50, and memory 60. In encoder 1, electric power generating element 100 in power generation system 5 generates power by a change in the magnetic field formed by magnet 10 due to the rotation of magnet 10, and outputs the generated power as an electric signal.

Rotating plate 20 is a plate-shaped member that rotates together with rotating shaft 30 that is a driving unit such as a motor. A central portion of one main surface of rotating plate 20 is attached to an end portion of rotating shaft 30 in the axial direction of rotating shaft 30 (the direction in which rotating shaft 30 extends). Rotating plate 20 extends in a direction orthogonal to the axial direction of rotating shaft 30. Rotating plate 20 rotates about a rotation axis A passing through the center of rotating shaft 30 and extending along the axial direction of rotating shaft 30. The rotating operation of rotating shaft 30 is synchronized with the rotating operation of the rotating device. Rotating plate 20 has, for example, a circular shape in plan view. Rotating plate 20 is made of, for example, metal, resin, glass, or ceramic.

Rotating shaft 30 has a rod shape such as a cylindrical shape. The axis of rotating shaft 30 and the rotation axis A coincide with each other.

Magnet 10 is an example of a magnetic field application unit that applies an external magnetic field to electric power generating element 100. Magnet 10 repeatedly reverses the direction of the magnetic field applied to electric power generating element 100. Magnet 10 is, for example, a plate-shaped magnet. Magnet 10 faces rotating plate 20 and is located on a main surface of rotating plate 20 opposite to rotating shaft 30. In the present embodiment, the pair of magnets 10 are provided on the same main surface of rotating plate 20. The thickness direction of rotating plate 20 and the thickness direction of magnet 10 are the same, and are the axial direction of rotating shaft 30. The pair of magnets 10 rotate about rotating shaft 30 (that is, about the rotation axis A) together with rotating plate 20. When the pair of magnets 10 rotate due to the rotation of rotating shaft 30, the relative positional relationship between the pair of magnets 10 and electric power generating element 100 changes, and the magnetic field from the pair of magnets 10 applied to electric power generating element 100 also changes. The rotation direction of the pair of magnets 10 is, for example, both clockwise and counterclockwise, but may be only one of clockwise and counterclockwise.

The pair of magnets 10 sandwich the rotation axis A of rotating shaft 30 and are arranged side by side at an interval on the same main surface of rotating plate 20. That is, the rotation axis A of rotating shaft 30 is located between the pair of magnets 10, and a space is formed. The pair of magnets 10 are arranged symmetrically with respect to the rotation axis A. The pair of magnets 10 have the same shape.

Each of the pair of magnets 10 is disposed along the rotation direction of rotating shaft 30. Each of the pair of magnets 10 has an arc shape in a plan view along the rotation direction of rotating shaft 30. Only one of the pair of magnets 10 may be provided on the main surface of rotating plate 20. Magnet 10 may be a magnet having another shape such as an annular, disk-shaped, or rod-shaped magnet as long as magnet 10 can change the magnetic field applied to electric power generating element 100. Magnet 10 is, for example, a permanent magnet, but may be an electromagnet.

The N pole and the S pole of each of the pair of magnets 10 are arranged along the direction in which the pair of magnets 10 are arranged. The S poles and the N poles of the pair of magnets 10 are arranged in the same order. That is, each of the pair of magnets 10 is magnetized in a direction in which the pair of magnets 10 are arranged. Therefore, each of the pair of magnets 10 generates a magnetic field along the direction in which the pair of magnets 10 are arranged.

One of the pair of magnets 10 has an S pole on the rotation axis A side, and the other magnet 10 has an N pole on the rotation axis A side. Therefore, when the pair of magnets 10 are rotated by the rotation of rotating shaft 30 and the positions of the pair of magnets 10 are switched with each other, the directions of the magnetic fields formed by the pair of magnets 10 are reversed. The rotation of the pair of magnets 10 changes the magnetic field applied to electric power generating element 100. Specifically, when the pair of magnets 10 rotate, the direction of the magnetic field applied to electric power generating element 100 is repeatedly reversed.

Substrate 40 is positioned on magnet 10 side of rotating plate 20 so as to face rotating plate 20 and magnet 10 with a gap therebetween. That is, rotating shaft 30, rotating plate 20, magnet 10, and substrate 40 are arranged in this order along the axial direction of rotating shaft 30. Substrate 40 does not rotate together with magnet 10 and rotating plate 20. Substrate 40 has a plate shape whose thickness direction is the axial direction of rotating shaft 30. Substrate 40 has, for example, a circular shape in plan view. For example, when viewed from the axial direction of rotating shaft 30, the centers of rotating shaft 30, rotating plate 20, and substrate 40 coincide with each other and are located at the position of the rotation axis A.

Substrate 40 is, for example, a wiring substrate, and electronic components such as electric power generating element 100, control circuit 50, and memory 60 are mounted on substrate 40. In the example illustrated in FIG. 1, control circuit 50 and memory 60 are mounted on the main surface of substrate 40 on magnet 10 side, and electric power generating element 100 is mounted on the main surface of substrate 40 on the side opposite to magnet 10. Substrate 40 is fixed to, for example, a case (not illustrated) constituting a part of encoder 1, a motor, or the like.

Electric power generating element 100 is located on a main surface of substrate 40 opposite to magnet 10 side. Therefore, the side of electric power generating element 100 facing substrate 40 faces magnet 10. Electric power generating element 100 is aligned with magnet 10 and rotating plate 20 along the axial direction of rotating shaft 30. Hereinafter, the direction indicated by the arrow Z in which magnet 10, rotating plate 20, and electric power generating element 100 are arranged may be referred to as an “arrangement direction”. In the present embodiment, the arrangement direction is also the axial direction of rotating shaft 30 and the normal direction of main surface 11 of magnet 10. Electric power generating element 100 does not rotate together with magnet 10 and rotating plate 20. The arrangement of electric power generating element 100 is not particularly limited, and electric power generating element 100 may be located in a region to which the magnetic field generated by magnet 10 is applied, and may be arranged to generate a power generation pulse by reversal of the direction of the magnetic field caused by the rotation of rotating shaft 30. For example, electric power generating element 100 may be located on the main surface of substrate 40 on magnet 10 side.

Electric power generating element 100 is provided to face rotating plate 20 in the axial direction of rotating shaft 30. Electric power generating element 100 is disposed at a position shifted from the rotation axis A without overlapping the rotation axis A when viewed from the axial direction of rotating shaft 30. When viewed in the axial direction of rotating shaft 30, electric power generating element 100 overlaps a position through which magnet 10 passes when rotating. Electric power generating element 100 extends along the main surface of substrate 40 so as to extend in the tangential direction of the rotation direction of magnet 10.

Electric power generating element 100 generates power by a change in the magnetic field formed by magnet 10 due to the rotation of magnet 10, specifically, by reversal of the direction of the magnetic field, and outputs the generated power. The winding axis direction of coil 130 of Electric power generating element 100 is the direction in which electric power generating element 100 extends. The winding axis direction of coil 130 coincides with the first direction D1 which is a predetermined direction in which magnetic member 110 extends (that is, the longitudinal direction of magnetic member 110).

Electric power generating element 100 includes, for example, a composite magnetic member including magnetic member 110 and the like, coil 130, terminal 181 and terminal 182, and housing 190. Details of the composite magnetic member and coil 130 will be described later.

Magnetic member 110 is a magnetic member that generates a large Barkhausen effect, and a power generation pulse is generated in coil 130 wound around magnetic member 110.

Terminal 181 and terminal 182 are members for electrically connecting electric power generating element 100 and substrate 40. Terminal 181 and terminal 182 are located at an end portion of electric power generating element 100 on substrate 40 side. Magnet 10 is disposed on terminal 181 and terminal 182 side of electric power generating element 100. Terminal 181 is electrically connected to one end of a conductive wire constituting coil 130, and terminal 182 is electrically connected to the other end of the conductive wire. That is, coil 130 and substrate 40 are electrically connected to each other via terminal 181 and terminal 182.

Housing 190 accommodates and supports the composite magnetic member including magnetic member 110 and coil 130. The composite magnetic member including magnetic member 110 and the like and coil 130 are, for example, embedded in a resin or the like in housing 190. Housing 190 accommodates a part of terminal 181 and terminal 182. For example, housing 190 opens to magnet 10 side in electric power generating element 100. Housing 190 is fixed to substrate 40 by, for example, a fixing member (not illustrated).

Control circuit 50 is located on the main surface of substrate 40 on magnet 10 side. Control circuit 50 is electrically connected to electric power generating element 100. Control circuit 50 acquires an electric signal such as a power generation pulse generated by electric power generating element 100, and detects (calculates) a rotation angle, a rotation amount, a rotation speed, and the like of rotating shaft 30 such as a motor based on the acquired electric signal. Control circuit 50 is, for example, an IC (integrated circuit) package or the like.

Memory 60 is located on the main surface of substrate 40 on magnet 10 side. Memory 60 is connected to control circuit 50. Memory 60 is a nonvolatile memory such as a semiconductor memory that stores a result detected by control circuit 50.

Next, a detailed configuration of electric power generating element 100 according to the present embodiment will be described.

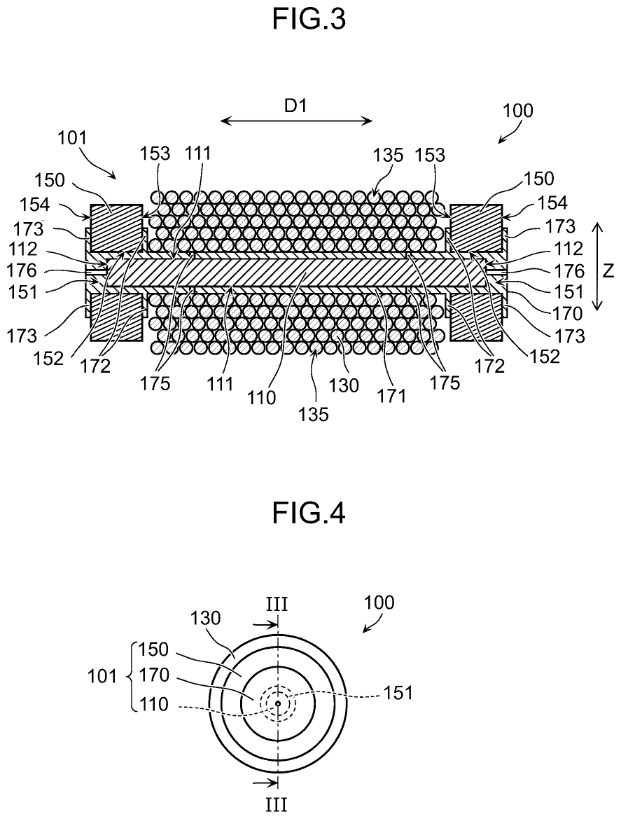

FIG. 3 is a cross-sectional view illustrating a schematic configuration of electric power generating element 100 according to the present embodiment. FIG. 4 is a plan view illustrating a schematic configuration of electric power generating element 100 according to the present embodiment. FIG. 3 illustrates a cross section taken along line III-III illustrated in FIG. 4. Specifically, FIG. 3 shows a cross section of electric power generating element 100 cut along the first direction D1 and the arrangement direction (direction Z) so as to pass through the center of magnetic member 110. FIG. 4 shows a plan view of electric power generating element 100 viewed from the outside along the first direction D1. In FIGS. 3 and 4, illustration of terminal 181, terminal 182, and housing 190 is omitted.

As shown in FIG. 3, electric power generating element 100 includes composite magnetic member 101 and coil 130. Composite magnetic member 101 is a member used in electric power generating element 100, and includes magnetic member 110, two flux concentrating members 150, and resin member 170.

Magnetic member 110 is a wire-shaped member extending in the first direction D1. Therefore, the longitudinal direction of magnetic member 110 is the first direction D1. It can also be said that the shape of magnetic member 110 is a long rod shape or a pillar shape. The cross-sectional shape of magnetic member 110 cut in a direction orthogonal to the first direction D1 is, for example, a circular shape or an elliptical shape, but is not particularly limited and may be another shape such as a rectangular shape or a polygonal shape. In the first direction D1, the length of magnetic member 110 is longer than the length of coil 130.

As described above, magnetic member 110 is a magnetic member that generates the large Barkhausen effect by a change in the external magnetic field formed by magnet 10 and the like. Magnetic member 110 is, for example, a composite magnetic wire such as a Wiegand wire having different magnetic characteristics between a central portion and an outer peripheral portion in the radial direction. In the composite magnetic wire, one of the central portion and the outer peripheral portion is a hard magnetic portion, and the other is a soft magnetic portion.

The composite magnetic wire has such a magnetic property that the magnetization direction of the soft magnetic portion is changed by application of a relatively small external magnetic field, whereas the magnetization direction of the hard magnetic portion is not changed unless a relatively large external magnetic field is applied. When a relatively large external magnetic field sufficient to reverse the direction of magnetization of the hard magnetic portion of the composite magnetic wire is applied in the longitudinal direction of the composite magnetic wire, the direction of magnetization of the hard magnetic portion and the direction of magnetization of the soft magnetic portion of the composite magnetic wire are aligned in the same direction. Thereafter, even if the direction of the external magnetic field applied to the composite magnetic wire is reversed, the magnetization direction of the hard magnetic portion and the magnetization direction of the soft magnetic portion are not reversed due to the influence of the hard magnetic portion while the external magnetic field is small. When the external magnetic field whose direction has been reversed is further increased, the magnetization direction of the soft magnetic portion is rapidly reversed when the external magnetic field exceeds a predetermined threshold. Such a phenomenon in which the magnetic field is rapidly reversed is also called a large Barkhausen jump. As a result, the magnetic flux density of the composite magnetic wire rapidly changes, and power (power generation pulse) is generated in coil 130 wound around the composite magnetic wire.

Note that magnetic member 110 is not limited to a composite magnetic wire such as a Wiegand wire, and may be any magnetic member that includes a hard magnetic portion and a soft magnetic portion having different magnetic characteristics to produce a large Barkhausen effect. In magnetic member 110, for example, the hard magnetic portion and the soft magnetic portion are arranged in a direction intersecting (for example, orthogonal to) the first direction D1, and the hard magnetic portion and the soft magnetic portion are present so as to extend in the first direction D1, whereby the large Barkhausen effect is generated. Magnetic member 110 may be a magnetic member having a structure in which thin films having different magnetic characteristics are stacked.

Two flux concentrating members 150 are spaced apart from each other and arranged side by side along the first direction D1. Space 135 for disposing coil 130 is provided between two flux concentrating members 150. Two flux concentrating members 150 are provided at both ends of magnetic member 110 so as to be aligned with coil 130 disposed in space 135 along the first direction D1. Two flux concentrating members 150 face each other with coil 130 interposed therebetween, and have symmetrical shapes. Hereinafter, one of two flux concentrating members 150 will be mainly described, but the same description is also applied to the other.

As shown in FIGS. 3 and 4, flux concentrating member 150 is a tubular member in which opening 151 is formed. Flux concentrating member 150 is, for example, a ferrite bead made of a soft magnetic material such as ferrite. Flux concentrating member 150 is provided to collect the magnetic flux from magnet 10, stabilize the magnetic flux in magnetic member 110, and the like. Flux concentrating member 150 is, for example, softer magnetic than the soft magnetic portion of magnetic member 110, that is, has a lower coercive force than that of the soft magnetic portion of magnetic member 110.

Flux concentrating member 150 is provided with opening 151 into which a part of magnetic member 110 is inserted. Opening 151 is a through hole penetrating flux concentrating member 150 along the first direction D1. Opening 151 is located at the center of flux concentrating member 150 when viewed along the first direction D1. The shape of each of the outer periphery of flux concentrating member 150 and opening 151 when viewed along the first direction D1 is, for example, circular. Therefore, flux concentrating member 150 has, for example, a cylindrical shape.

An end of magnetic member 110 in the first direction D1 is located in opening 151 and is surrounded by flux concentrating member 150. Therefore, in the first direction D1, end surface 154 of flux concentrating member 150 on the side opposite to space 135 side is located outside end surface 112 of magnetic member 110. That is, in the first direction D1, end surface 154 is located on the side opposite to space 135 side of end surface 112. In the present specification, the outer side in the first direction D1 is a direction away from the center of magnetic member 110 in the first direction D1, and the inner side in the first direction D1 is a direction approaching the center of magnetic member 110 in the first direction D1. In the first direction D1, end surface 154 may be located at the same position as that of end surface 112 or may be located inside end surface 112. That is, magnetic member 110 may penetrate opening 151.

Resin member 170 fixes magnetic member 110 and two flux concentrating members 150. Resin member 170 is in contact with magnetic member 110 and two flux concentrating members 150. In composite magnetic member 101, magnetic member 110 and two flux concentrating members 150 are fixed to resin member 170 so that the relative positions of magnetic member 110 and two flux concentrating members 150 do not change. Resin member 170 is, for example, a resin molded product formed by being integrally molded with magnetic member 110 and two flux concentrating members 150.

Resin member 170 includes first covering portion 171, second covering portion 172, and third covering portion 173. First covering portion 171, second covering portion 172, and third covering portion 173 are names given to different portions formed by processing one member made of the same material, for example. First covering portion 171, second covering portion 172, and third covering portion 173 may be formed of different members. Resin member 170 may have at least first covering portion 171, and the shape of resin member 170 is not particularly limited as long as magnetic member 110 and two flux concentrating members 150 can be fixed. For example, resin member 170 need not include at least one of second covering portion 172 and third covering portion 173.

First covering portion 171 covers outer peripheral surface 111 of magnetic member 110. Outer peripheral surface 111 is a surface constituting the outer periphery of magnetic member 110 when viewed along the first direction D1, and can also be said to be a radial surface of magnetic member 110. First covering portion 171 is in contact with outer peripheral surface 111 of magnetic member 110. First covering portion 171 covers at least a portion of outer peripheral surface 111 of magnetic member 110 between at least two flux concentrating members 150. In the example shown in FIG. 3, first covering portion 171 covers the entire outer peripheral surface 111 of magnetic member 110 except for a portion where hole 175 described later is formed. Outer peripheral surface 111 of magnetic member 110 may have a portion not covered with first covering portion 171 other than the portion where hole 175 is formed. First covering portion 171 covers, for example, a region of 90% or more of outer peripheral surface 111 of magnetic member 110. First covering portion 171 may cover a region of 95% or more of outer peripheral surface 111 of magnetic member 110.

First covering portion 171 fills a space between inner wall 152 of opening 151 and outer peripheral surface 111 of magnetic member 110 in opening 151 of flux concentrating member 150. Accordingly, the relative positions of magnetic member 110 and two flux concentrating member 150 in the direction orthogonal to the first direction D1 are less likely to be displaced. In the example shown in FIGS. 3 and 4, magnetic member 110 is disposed in opening 151 of flux concentrating member 150 such that the distance between inner wall 152 of opening 151 and outer peripheral surface 111 of magnetic member 110 is uniform. The distance between inner wall 152 of opening 151 and outer peripheral surface 111 of magnetic member 110 is maintained by first covering portion 171. Accordingly, the magnetic flux collected by flux concentrating member 150 is uniformly transmitted to magnetic member 110, and thus a uniform magnetic field is easily applied to entire magnetic member 110, and it is possible to reduce variation in the power generation amount in electric power generating element 100. In the example shown in FIGS. 3 and 4, when viewed along the first direction D1, the shape of magnetic member 110 and the shape of opening 151 are similar to each other, and the center of magnetic member 110 and the center of opening 151 coincide with each other. The distance between inner wall 152 of opening 151 and outer peripheral surface 111 of magnetic member 110 need not be uniform. For example, magnetic member 110 may be in contact with inner wall 152 of opening 151 of flux concentrating member 150. When viewed along the first direction D1, the shape of magnetic member 110 and the shape of opening 151 of flux concentrating member 150 need not be similar to each other.

In the example shown in FIGS. 3 and 4, first covering portion 171 completely fills a space between inner wall 152 of opening 151 and outer peripheral surface 111 of magnetic member 110 in opening 151 of flux concentrating member 150, and is in contact with inner wall 152 and outer peripheral surface 111. In opening 151, a portion between inner wall 152 and outer peripheral surface 111 of magnetic member 110 need not be filled with first covering portion 171.

Second covering portion 172 protrudes from first covering portion 171 in a direction orthogonal to the first direction D1. Second covering portion 172 covers end surface 153 of flux concentrating member 150 on space 135 side. Accordingly, flux concentrating member 150 is firmly fixed by resin member 170. Second covering portion 172 is in contact with end surface 153 of flux concentrating member 150. In the example shown in FIG. 3, second covering portion 172 covers a part of end surface 153 of flux concentrating member 150. Second covering portion 172 may cover entire end surface 153 of flux concentrating member 150.

Third covering portion 173 covers end surface 154 of flux concentrating member 150 opposite to space 135. Accordingly, flux concentrating member 150 is firmly fixed by resin member 170. Third covering portion 173 is in contact with end surface 154 of flux concentrating member 150. In the example shown in FIG. 3, third covering portion 173 covers a part of end surface 154 of flux concentrating member 150. Third covering portion 173 may cover entire end surface 154 of flux concentrating member 150.

A part of third covering portion 173 enters opening 151 of flux concentrating member 150 and is connected to first covering portion 171 at opening 151. Third covering portion 173 covers end surface 112 of magnetic member 110 in opening 151. Third covering portion 173 is in contact with inner wall 152 of opening 151 and end surface 112 of magnetic member 110. In the example shown in FIG. 3, the inside of opening 151 is filled with resin member 170 except for a hole 176 described later.

Resin member 170 is provided with hole 175 and hole 176 extending from the surface of resin member 170 toward magnetic member 110. Hole 175 and hole 176 are formed by forming resin member 170 in a state where a jig for positioning magnetic member 110 is pressed against magnetic member 110. In the example illustrated in FIG. 3, the inside of hole 175 and hole 176 is hollow, but at least a part of hole 175 and hole 176 may be filled with a material such as a resin.

Hole 175 penetrates first covering portion 171 along the normal direction of outer peripheral surface 111 of each magnetic member 110, and exposes outer peripheral surface 111 of magnetic member 110. Hole 176 penetrates third covering portion 173 along the first direction D1 and exposes end surface 112 of magnetic member 110. In the example shown in FIG. 3, a plurality of holes 175 and a plurality of holes 176 are provided. For example, a plurality of holes 175 are disposed at symmetrical positions with magnetic member 110 interposed therebetween in a direction orthogonal to the first direction D1. For example, the plurality of holes 176 are disposed at symmetrical positions with respect to magnetic member 110 in the first direction D1. The arrangement and the number of holes 175 and holes 176 are not particularly limited as long as they correspond to the arrangement of a jig capable of positioning magnetic member 110 at the time of forming resin member 170. Depending on the method of forming resin member 170, hole 175 and hole 176 may not be provided in resin member 170.

Resin member 170 is formed of, for example, a thermoplastic resin. Examples of the thermoplastic resin include liquid crystal polymers (LCP) such as liquid crystal polyester, polyphenylene sulfide (PPS), and polyamide (PA). Resin member 170 may be formed of a thermosetting resin.

Coil 130 is a coil in which a conductive wire constituting coil 130 is wound around magnetic member 110 via first covering portion 171 of resin member 170. Specifically, coil 130 is wound along a winding axis that passes through the center of magnetic member 110 and extends in the first direction D1. In the first direction D1, coil 130 is located between two end surfaces 112 on both sides of magnetic member 110. At least a part of coil 130 is located in space 135 between two flux concentrating members 150. Second covering portion 172 is disposed between coil 130 and flux concentrating member 150.

### Production Method

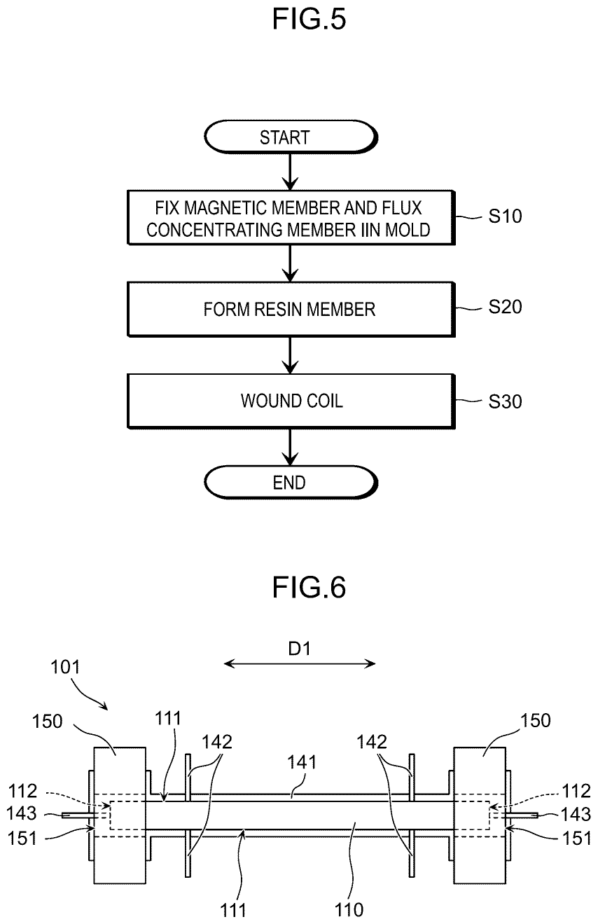

Next, a method for manufacturing electric power generating element 100 according to the present embodiment will be described. Electric power generating element 100 is manufactured by, for example, a manufacturing method described below with reference to FIGS. 5 and 6.

FIG. 5 is a flowchart showing an example of a method of manufacturing electric power generating element 100 according to the present embodiment.

In manufacturing electric power generating element 100, first, magnetic member 110 and two flux concentrating members 150 are fixed in a mold for resin molding (step S10). FIG. 6 is a plan view for explaining a state in which magnetic member 110 and flux concentrating member 150 are fixed in the mold. As shown in FIG. 6, recess 141 into which resin is poured is formed in the mold, and magnetic member 110 and two flux concentrating members 150 are disposed in recess 141. In the mold, for example, a plurality of pins 142 and pins 143 are installed as a jig for positioning magnetic member 110, and magnetic member 110 is fixed to the mold by the plurality of pins 142 and pins 143. The plurality of pins 142 are in contact with outer peripheral surface 111 of magnetic member 110 and sandwich magnetic member 110 in a direction orthogonal to the first direction D1. The plurality of pins 143 are in contact with end surface 112 of magnetic member 110 and sandwich magnetic member 110 in the first direction D1. Recess 141 has, for example, a portion into which a part of flux concentrating member 150 can be fitted, and flux concentrating member 150 is fixed to the mold by being fitted into the portion. The method of fixing magnetic member 110 and two flux concentrating members 150 to the mold is not particularly limited as long as the positions of magnetic member 110 and two flux concentrating members 150 are fixed so as not to change in the formation of resin member 170 in the subsequent step. For example, magnetic member 110 may be fixed using a magnet.

Next, in the manufacturing of electric power generating element 100, resin member 170 is formed by pouring resin into a mold (step S20). As a result, resin member 170 having the shape shown in FIG. 3 is molded, and composite magnetic member 101 in which magnetic member 110, two flux concentrating members 150, and resin member 170 are integrally molded is obtained. As the resin, for example, the above-described thermoplastic resin is used. The formation position and shape of resin member 170 can be adjusted by the shape of the mold. The shape of resin member 170 may be further processed after molding. In this processing, a part of the portion where resin member 170 is formed may be removed, or a resin may be added by applying a resin to the formed resin member 170.

In this way, resin member 170 that fixes magnetic member 110 and two flux concentrating members 150 is formed by integral molding, so that the relative positions of magnetic member 110 and two flux concentrating members 150 can be fixed easily and accurately, and variations in the relative positions of magnetic member 110 and two flux concentrating members 150 in each manufacturing process can be reduced. It is also conceivable that magnetic member 110 and flux concentrating member 150 are separately prepared and assembled, and then fixed with an adhesive or the like. However, in this method, it is difficult to increase the positional accuracy of magnetic member 110 and flux concentrating member 150. Therefore, forming resin member 170 by integral molding is effective in reducing variations in the relative positions of magnetic member 110 and two flux concentrating members 150.

Next, in the manufacturing of electric power generating element 100, coil 130 is wound around magnetic member 110 via first covering portion 171 (step S30). For example, coil 130 can be formed by directly winding the conductive wire constituting coil 130 around magnetic member 110 covered with first covering portion 171. Therefore, it is not necessary to separately manufacture coil 130, and the manufacturing process can be simplified. In addition, since outer circumferential surface 111 of magnetic member 110 is covered with first covering portion 171, insulation between magnetic member 110 and coil 130 can also be ensured without performing a separate insulation treatment.

Thereafter, composite magnetic member 101 on which coil 130 is formed is accommodated in housing 190, and coil 130 and terminal 181 and terminal 182 are electrically connected to each other, whereby electric power generating element 100 is obtained.

### Relationship Between Relative Position of Magnetic Member and Flux Concentrating Member and Power Generation Amount

In electric power generating element 100 according to the present embodiment, since magnetic member 110 and two flux concentrating members 150 are fixed by resin member 170, it is possible to suppress the deviation of the relative position between magnetic member 110 and two flux concentrating members 150. Accordingly, it is possible to reduce variation in the power generation amount of electric power generating element 100. Here, the point that the suppression of the deviation of the relative position between magnetic member 110 and flux concentrating member 150 is important for the reduction of the variation in the power generation amount of electric power generating element 100 will be described with reference to the results of the study by the inventors of the present application.

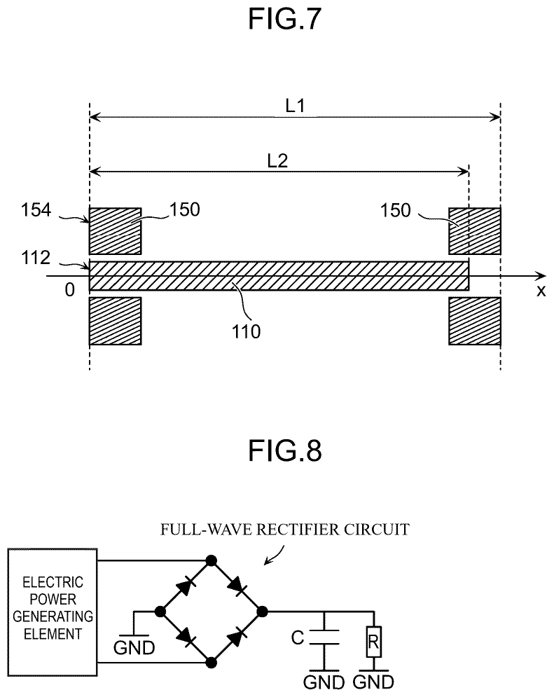

The inventors of the present application measured the generated voltage in the power generating element when the relative position between magnetic member 110 and flux concentrating member 150 was changed. FIG. 7 is a diagram for explaining the positional relationship between magnetic member 110 and flux concentrating member 150 in the power generating element used for measuring the generated voltage. FIG. 8 is a schematic diagram illustrating a circuit used for measuring the power generation voltage of the power generation element. Although only magnetic member 110 and flux concentrating member 150 are shown in FIG. 7, a power generating element in which coil 130 is wound around magnetic member 110 was used for the measurement.

As shown in FIG. 7, flux concentrating members 150 were arranged such that the longitudinal direction thereof was the x-axis direction. In the x-axis direction, the position of end surface 154 of one of flux concentrating members 150 was set to 0 mm, and the position of end surface 112 of magnetic member 110 in the x-axis direction (hereinafter referred to as “x position”) was changed to 0 mm, 0.3 mm, and 0.6 mm. The distance L1 between end surfaces 154 of two flux concentrating members 150 was fixed at 11.5 mm. The length L2 of magnetic member 110 was 10.7 mm. The width (length in the x-axis direction) of flux concentrating member 150 was 1.3 mm.

A power generating element was connected to a circuit as shown in FIG. 8. Specifically, the output of the power generation element was connected to a full-wave rectifier circuit connected to a capacitor C and a resistor R. An AC magnetic field of 20 Hz in the range of 20 Oe to 200 Oe was applied to the power generating element connected to such a circuit. In the measurement of the power generation voltage, the peak voltage after rectification of the power generation pulse by the power generation element was measured every time the direction of the AC magnetic field was reversed. In addition, the peak voltage was measured 2500 times, and the average value of the measured 2500 peak voltages was derived. Here, Oe is a unit of magnetic field strength, and 1 Oe=(1/(4π)) 10³ A/m. Note that π is the circular constant.

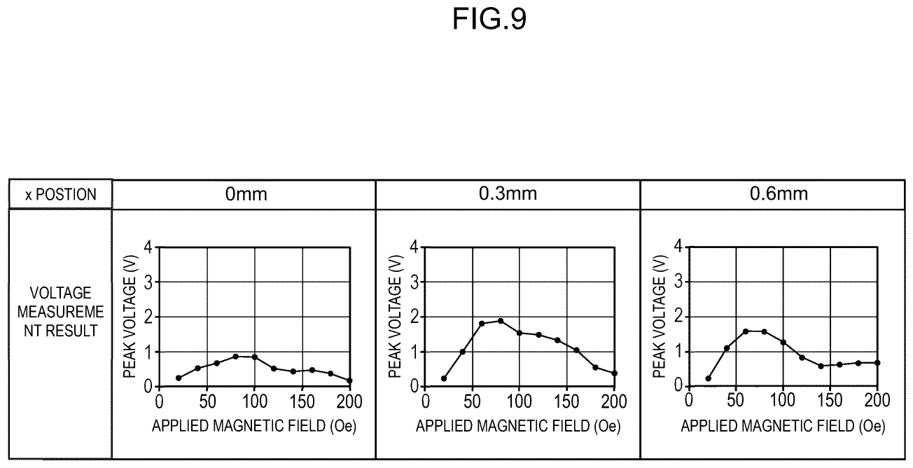

FIG. 9 is a diagram illustrating a power generation result of the power generation element. FIG. 9 shows a measurement result at each x position of end surface 112 of magnetic member 110. As shown in FIG. 9, it can be seen that even if the x position of end surface 112 of magnetic member 110 is shifted by 0.3 mm, the peak voltage in the power generation of the power generating element changes by about 1 V at the maximum. It is considered that the change in the relative position between magnetic member 110 and flux concentrating member 150 changes the magnitude of the magnetic field applied to magnetic member 110 via flux concentrating member 150 that easily collects the magnetic flux, and affects the power generation voltage of the power generation element, that is, the power generation amount.

As described above, in composite magnetic member 101 according to the present embodiment, since resin member 170 fixes magnetic member 110 and two flux concentrating members 150, it is possible to suppress the deviation of the relative position between magnetic member 110 and two flux concentrating members 150. For example, since magnetic member 110 and two flux concentrating members 150 are fixed by resin member 170, the relative positions of magnetic member 110 and flux concentrating member 150 are suppressed from being shifted when coil 130 is wound around magnetic member 110 and when magnetic member 110 and flux concentrating member 150 are assembled to housing 190. As can be seen from the measurement result of the generated voltage, the power generation amount of electric power generating element 100 strongly depends on the relative position between magnetic member 110 and flux concentrating member 150. Therefore, by using composite magnetic member 101 capable of suppressing the deviation of the relative position between magnetic member 110 and two flux concentrating members 150 in electric power generating element 100, the variation in the power generation amount of electric power generating element 100 can be reduced.

Resin member 170 that fixes magnetic member 110 and two flux concentrating members 150 includes first covering portion 171 that covers outer peripheral surface 111 of magnetic member 110. As a result, even when coil 130 is wound around magnetic member 110, first covering portion 171 serves as an insulating material to ensure insulation between magnetic member 110 and coil 130. Therefore, composite magnetic member 101 can be used as a winding frame of coil 130, and electric power generating element 100 capable of reducing variation in the amount of power generation can be easily formed.

### Modification 1

Next, a first modification of the embodiment will be described. In the following description of Modification 1, differences from the embodiment will be mainly described, and description of common points will be omitted or simplified.

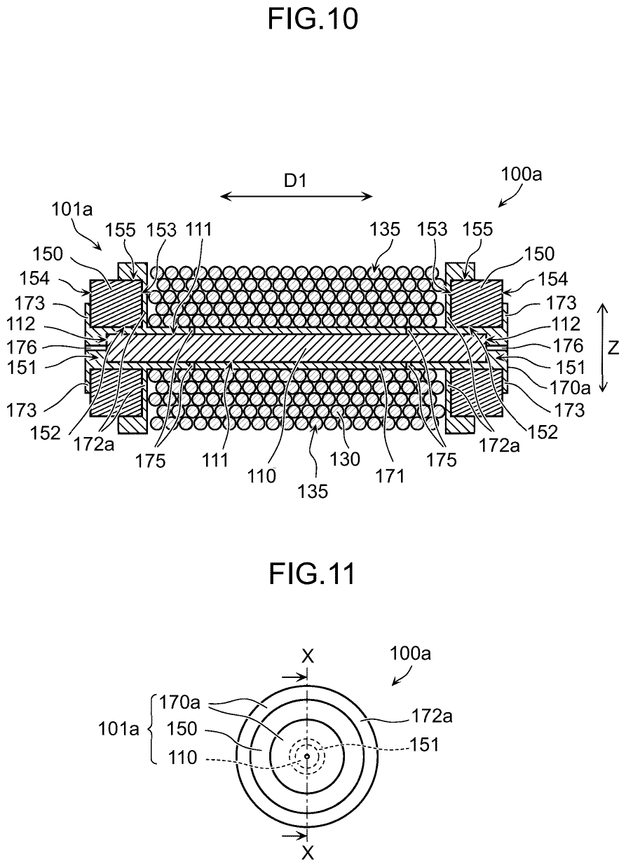

FIG. 10 is a cross-sectional view showing a schematic configuration of electric power generating element 100a according to the present modification. FIG. 11 is a plan view showing a schematic configuration of electric power generating element 100a according to the present modification. FIG. 10 illustrates a cross section taken along line X-X illustrated in FIG. 11. Specifically, FIG. 10 shows a cross section of electric power generating element 100a cut along the first direction D1 and the arrangement direction (direction Z) so as to pass through the center of magnetic member 110. FIG. 11 shows a plan view of electric power generating element 100a viewed from the outside along the first direction D1. In FIGS. 10 and 11, illustration of terminal 181, terminal 182, and housing 190 is omitted.

Electric power generating element 100a is used, for example, instead of electric power generating element 100 of encoder 1 described above. As shown in FIGS. 10 and 11, electric power generating element 100a includes composite magnetic member 101a including magnetic member 110, two flux concentrating member 150, and resin member 170a, and coil 130.

Resin member 170a has a configuration in which second covering portion 172 of resin member 170 is changed to second covering portion 172a.

Second covering portion 172a covers entire end surface 153 of flux concentrating member 150 on space 135 side, and extends onto outer peripheral surface 155 of flux concentrating member 150. Outer peripheral surface 155 is a surface constituting the outer periphery of flux concentrating member 150 when viewed along the first direction D1. Second covering portion 172a extends to the outside of two flux concentrating members 150 and coil 130 when viewed along the first direction D1. Accordingly, coil 130 can be supported by second covering portion 172a extending to the outside of flux concentrating member 150, and coil 130 can be easily formed even when the number of turns of coil 130 in the radial direction is increased. For example, the number of turns of coil 130 in the radial direction of magnetic member 110 can be increased without performing a process for maintaining the shape of coil 130.

### Modification 2

Next, a second modification of the embodiment will be described. In the following description of Modification 2, differences from the embodiment and Modification 1 will be mainly described, and description of common points will be omitted or simplified.

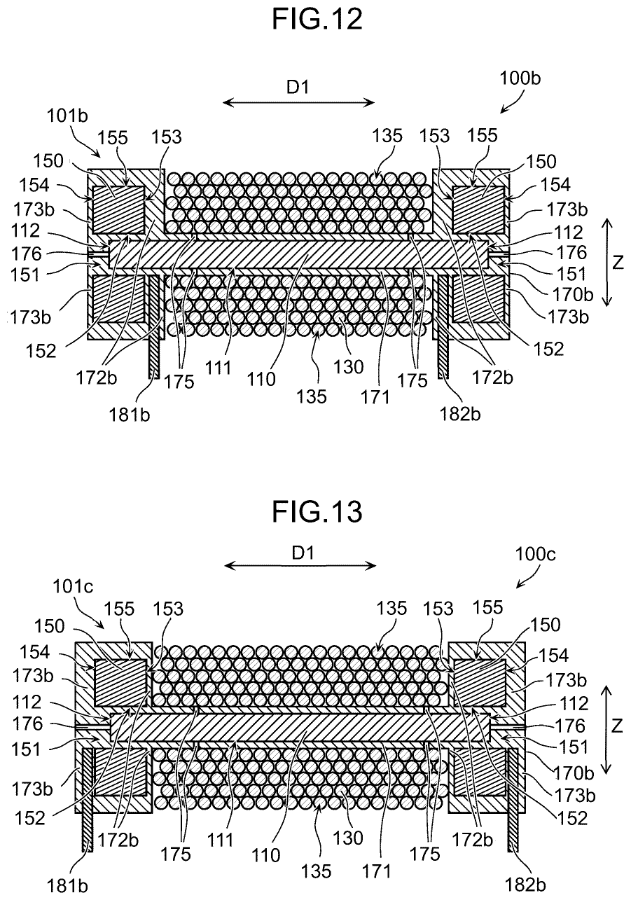

FIG. 12 is a cross-sectional view showing a schematic configuration of electric power generating element 100b according to the present modification. FIG. 13 is a cross-sectional view illustrating a schematic configuration of another electric power generating element 100c according to the present modification example. FIGS. 12 and 13 respectively show cross sections of electric power generating element 100b and electric power generating element 100c cut along the first direction D1 and the arrangement direction (direction Z) so as to pass through the center of magnetic member 110. In FIGS. 12 and 13, illustration of housing 190 is omitted.

Each of electric power generating element 100b and electric power generating element 100c is used, for example, instead of electric power generating element 100 of encoder 1 described above. As shown in FIG. 12, electric power generating element 100b includes composite magnetic member 101b and coil 130. Composite magnetic member 101b includes magnetic member 110, two flux concentrating members 150, resin member 170b, and terminal 181b and terminal 182b. As shown in FIG. 13, electric power generating element 100c includes composite magnetic member 101c and coil 130. Composite magnetic member 101c includes magnetic member 110, two flux concentrating members 150, resin member 170b, and terminal 181b and terminal 182b. Electric power generating element 100b and electric power generating element 100c do not include terminal 181 and terminal 182 illustrated in FIG. 1, and terminal 181b and terminal 182b are electrically connected to substrate 40.

As shown in FIGS. 12 and 13, composite magnetic member 101b and composite magnetic member 101c have the same components, but the positions of terminal 181b and terminal 182b are different from each other.

Resin member 170b has a configuration in which second covering portion 172 and third covering portion 173 of resin member 170 are changed to second covering portion 172b and third covering portion 173b.

Resin member 170b fixes magnetic member 110, two flux concentrating members 150, and terminal 181b and terminal 182b. Thus, in composite magnetic member 101b and composite magnetic member 101c, in addition to magnetic member 110 and two flux concentrating members 150, terminal 181b and terminal 182b are fixed to resin member 170b. Therefore, the connection between coil 130 and terminal 181b and terminal 182b is facilitated, and electric power generating element 100b and electric power generating element 100c can be easily formed.

Resin member 170b is in contact with magnetic member 110, two flux concentrating members 150, and terminal 181b and terminal 182b. In composite magnetic member 101b and composite magnetic member 101c, magnetic member 110, two flux concentrating members 150, and terminal 181b and terminal 182b are fixed to resin member 170b so that the relative positions of magnetic member 110, two flux concentrating members 150, and terminal 181b and terminal 182b do not change. For example, terminal 181b and terminal 182b are fixed to resin member 170b so as not to come into contact with magnetic member 110 and flux concentrating member 150. Resin member 170b is, for example, a resin molded product formed by being integrally molded with magnetic member 110, two flux concentrating members 150, and terminal 181b and terminal 182b. Resin member 170b provided with holes for fixing terminal 181b and terminal 182b may be formed, and terminal 181b and terminal 182b may be fixed to the holes.

Second covering portion 172b covers entire end surface 153 of flux concentrating member 150 on space 135 side, and extends onto outer peripheral surface 155 of flux concentrating member 150. Third covering portion 173b covers the entire surface of end surface 154 of flux concentrating member 150 on the side opposite to space 135 side, and extends onto outer peripheral surface 155 of flux concentrating member 150. Second covering portion 172b and third covering portion 173b are connected to each other on outer peripheral surface 155.

Terminal 181b and terminal 182b are electrically connected to coil 130. Specifically, terminal 181b is electrically connected to one end of the conductive wire constituting coil 130, and terminal 182b is electrically connected to the other end of the conductive wire. For example, the conductive wire is wound around and soldered to terminal 181b and terminal 182b. In FIGS. 12 and 13, the conductive wires wound around terminal 181b and terminal 182b are not shown.

As shown in FIG. 12, in composite magnetic member 101b, terminal 181b and terminal 182b are disposed between two flux concentrating members 150 in the first direction D1. Specifically, terminal 181b is fixed to second covering portion 172b covering end surface 153 of one flux concentrating member 150, and is located between coil 130 disposed in space 135 and one flux concentrating member 150. Terminal 182b is fixed to second covering portion 172b covering end surface 153 of the other flux concentrating member 150, and is located between coil 130 disposed in space 135 and the other flux concentrating member 150. Accordingly, since coil 130 and terminal 181b and terminal 182b are close to each other, it is easy to form coil 130 electrically connected to terminal 181b and terminal 182b.

As illustrated in FIG. 13, in composite magnetic member 101c, terminal 181b and terminal 182b are disposed on the side opposite to space 135 side of two flux concentrating members 150 in the first direction D1. Specifically, terminal 181b is fixed to third covering portion 173b covering end surface 154 of one flux concentrating member 150. Terminal 182b is fixed to third covering portion 173b covering end surface 154 of the other flux concentrating member 150. Accordingly, it is possible to secure a large region in which coil 130 is wound, and it is possible to secure the power generation amount of electric power generating element 100c.

### Others

Although the composite magnetic member, the power generation element, the power generation system, and the encoder according to the present disclosure have been described above based on the embodiments, the present disclosure is not limited to the above-described embodiments. The present disclosure also includes forms obtained by applying various modifications conceived by those skilled in the art to the above embodiments and forms realized by arbitrarily combining the components and functions in the embodiments without departing from the spirit of the present disclosure.

For example, in the above embodiment, composite magnetic member 101 is formed by integrally molding magnetic member 110, two flux concentrating members 150, and resin member 170, but is not limited thereto. For example, the relative positions of magnetic member 110 and two flux concentrating members 150 may be fixed by forming first covering portion 171 by coating outer peripheral surface 111 of magnetic member 110 with a resin by application or the like, and press-fitting magnetic member 110 on which first covering portion 171 is formed into openings 151 of two flux concentrating members 150. That is, the composite magnetic member may be formed by assembling magnetic member 110 in which at least a part of resin member 170 is formed and flux concentrating member 150.

In addition, for example, in the above-described embodiment, opening 151 of flux concentrating member 150 is a through hole, but is not limited thereto. Opening 151 of flux concentrating member 150 may be a bottomed hole that is open only on the inner side in the first direction D1 and does not penetrate.

For example, in the above-described embodiment, the position of electric power generating element 100 is fixed, and the magnet 10 is rotated by the rotation of the rotation shaft, so that the direction of the magnetic field applied to electric power generating element 100 is repeatedly reversed. However, it is not limited thereto. The direction of the magnetic field applied to electric power generating element 100 may be repeatedly reversed by fixing the position of magnet 10 and rotating electric power generating element 100 by the rotation of the rotation shaft.

Further, for example, in the above embodiment, the rotary encoder used in combination with the motor has been described as an example, but is not limited thereto. The technology of the present disclosure can also be applied to a linear encoder.

Examples of the composite magnetic member, the power generation element, the power generation system, and the encoder according to the present disclosure described based on the above embodiments will be described below. The composite magnetic member, the power generation element, the power generation system, and the encoder according to the present disclosure are not limited to the following examples.

For example, a composite magnetic member according to a first aspect of the present disclosure is a magnetic member that generates a large Barkhausen effect by a change in an external magnetic field, the composite magnetic member including: a magnetic member extending in a first direction, the magnetic member having a wire shape; two flux concentrating members disposed side by side along the first direction while being separated from each other, the two flux concentrating members being provided with an opening into which a part of the magnetic member is inserted; and a resin member that fixes the magnetic member and the two flux concentrating members, wherein the resin member has a first covering portion that covers an outer peripheral surface of the magnetic member at least between the two flux concentrating members, and a space for disposing a coil is provided between the two flux concentrating members.

For example, a composite magnetic member according to a second aspect of the present disclosure is the composite magnetic member according to the first aspect, wherein the first covering portion fills at least a portion between an inner wall of the opening and the outer peripheral surface of the magnetic member in the opening of the flux concentrating member.

For example, a composite magnetic member according to a third aspect of the present disclosure is the composite magnetic member according to the second aspect, wherein the magnetic member is disposed in the opening of the flux concentrating member such that a distance between the inner wall and the outer peripheral surface of the magnetic member is uniform.

Further, for example, a composite magnetic member according to a fourth aspect of the present disclosure is the composite magnetic member according to any one of the first aspect to the third aspect, further including a terminal for electrically connecting to the coil, wherein the resin member fixes the magnetic member, the two flux concentrating members, and the terminal.

For example, a composite magnetic member according to a fifth aspect of the present disclosure is the composite magnetic member according to the fourth aspect, wherein the terminal is disposed between the two flux concentrating members in the first direction.

For example, a composite magnetic member according to a sixth aspect of the present disclosure is the composite magnetic member according to the fourth aspect, wherein the terminal is disposed on a side opposite to the space side of the two flux concentrating members in the first direction.

For example, a composite magnetic member according to a seventh aspect of the present disclosure is the composite magnetic member according to any one of the first to sixth aspects, wherein the resin member includes a second covering portion that covers surfaces of the two flux concentrating members facing to the space.

In addition, for example, a composite magnetic member according to an eighth aspect of the present disclosure is the composite magnetic member according to the seventh aspect, wherein the second covering portion extends outward beyond the two flux concentrating members when viewed along the first direction.

For example, a composite magnetic member according to a ninth aspect of the present disclosure is the composite magnetic member according to any one of the first to eighth aspects, wherein the resin member is provided with a hole extending from a surface of the resin member toward the magnetic member.

In addition, for example, a power generation element according to a tenth aspect of the present disclosure includes the composite magnetic member according to any one of the first aspect to the ninth aspect, and a coil wound around the magnetic member via the first covering portion.

For example, a power generation system according to an eleventh aspect of the present disclosure includes: the power generation element according to the tenth aspect; and a magnetic field application unit that applies a magnetic field to the power generation element and repeatedly reverses a direction of the magnetic field applied to the power generation element, wherein the power generation element generates power by reversal of the direction of the magnetic field by the magnetic field application unit.

Further, for example, an encoder according to a twelfth aspect of the present disclosure includes the power generation system according to the eleventh aspect, and the power generation element outputs power generated by reversal of the direction of the magnetic field by the magnetic field application unit.

### INDUSTRIAL APPLICABILITY

The composite magnetic member, the power generation element, the power generation system, and the encoder according to the present disclosure are useful for rotating or linearly moving equipment, devices, and the like such as a motor.

### REFERENCE MARKS IN THE DRAWINGS

1 encoder
5 power generation system
10 magnet
11 main surface
20 rotating plate
30 rotating shaft
40 substrate
50 control circuit
60 memory
100, 100a, 100b, 100c electric power generating element
101, 101a, 101b, 101c composite magnetic member
110 magnetic member
111,155 outer peripheral surface
112,153,154 end surface
130 coil
135 space
141 recess
142,143 pins
150 flux concentrating member
151 opening
152 inner wall
170, 170a, 170b resin member
171 first covering portion
172, 172 a, 172b second covering portion
173, 173b third covering portion
175,176 hole
181, 181b, 182, 182b terminal
190 housing

1. A composite magnetic member comprising:
a magnetic member that generates a large Barkhausen effect by a change in an external magnetic field and extends in a first direction, the magnetic member having a wire shape;
two flux concentrating members that are spaced apart from each other and disposed side by side along the first direction, the two flux concentrating members each including an opening into which a part of the magnetic member is inserted; and
a resin member that fixes the magnetic member and the two flux concentrating members,
wherein the resin member includes a first covering portion that covers an outer peripheral surface of the magnetic member at least between the two flux concentrating members, and a space for disposing a coil is provided between the two flux concentrating members.

2. The composite magnetic member according to claim 1, wherein the first covering portion fills at least a portion between an inner wall of the opening and the outer peripheral surface of the magnetic member in the opening.

3. The composite magnetic member according to claim 2, wherein the magnetic member is disposed such that a distance between the inner wall and the outer peripheral surface of the magnetic member is uniform in the opening.

4. The composite magnetic member according to claim 1, further comprising a terminal electrically connected to the coil, wherein the resin member fixes the magnetic member, the two flux concentrating members, and the terminal.

5. The composite magnetic member according to claim 4, wherein the terminal is disposed between the two flux concentrating members in the first direction.

6. The composite magnetic member according to claim 4, wherein the terminal is disposed on a opposite side from the space provided between the two flux concentrating members in the first direction.

7. The composite magnetic member according to claim 1, wherein the resin member includes a second covering portion that covers surfaces of the two magnetic flux concentrators facing to the space.

8. The composite magnetic member according to claim 7, wherein the second covering portion extends outward beyond the two flux concentrating members when viewed along the first direction.

9. The composite magnetic member according to claim 1, wherein the resin member is provided with a hole extending from a surface of the resin member toward the magnetic member.

10. A power generation element comprising:
the composite magnetic member according to claim 1; and
a coil wound around the magnetic member via the first covering portion.

11. A power generation system comprising:
the power generation element according to claim 10; and
a magnetic field application unit that applies a magnetic field to the power generation element and repeatedly reverses a direction of the magnetic field applied to the power generation element,
wherein the power generation element generates power by reversing the direction of the magnetic field by the magnetic field application unit.

12. An encoder comprising the power generation system according to claim 11,
wherein the power generation element outputs power generated by reversing the direction of the magnetic field by the magnetic field application unit.
